(19) United States
(12) Patent Application Publication
(10) Pub. No.: US 2015/0114503 A1
(43) Pub. Date: Apr. 30, 2015

(54) Adjustable Fluid Couplings and Systems

(71) Applicant: DC FITTINGS, LLC, Danbury, CT (US)

(72) Inventors: Bradley Fallot, Palm Court, FL (US); Daniel Eugene Waites, Carroll, OH (US); Christopher R. O'Keefe, Columbus, OH (US); Bridget MacKenzie Crawford, Rocky River, OH (US); Daniel Francis Falls, Brookfield, CT (US); Christopher Michael Falls, Danbury, CT (US)

(73) Assignee: DC FITTINGS, LLC, Danbury, CT (US)

(21) Appl. No.: 14/063,287

(22) Filed: Oct. 25, 2013

(51) Int. Cl. F16L 27/047

(52) U.S. Cl. CPC F16L 27/047
USPC 137/798; 285/261

(57) ABSTRACT

An adjustable drainage coupling includes a housing comprising a first end, a second end, and an inner cavity positioned between the first end and the second end, the second end comprising a securing apparatus, and a drainage apparatus comprising an inlet pipe, an outlet pipe, and a pivoting body fluidly coupled to the inlet pipe and the outlet pipe, the pivoting body configured such that the outlet pipe may pivot with respect to the inlet pipe. The drainage apparatus is positioned such that the pivoting body of the drainage apparatus is enclosed within the inner cavity of the housing, and a locking portion of the outlet pipe is secured to the second end of the housing by the securing apparatus, such that the outlet pipe is secured to the second end of the housing at a desired angle.

### TECHNICAL FIELD

The present disclosure relates generally to fluid coupling devices and systems, and in one embodiment to such devices and systems, fluid coupling devices with adjustable outlet portions.

### BACKGROUND

Fluid couplings may be used to transport fluid from one body to another. For example, in the construction industry, fluid couplings may be used in plumbing, heating, or sewerage systems. Fluid coupling may include piping and fittings. However, fittings may not always make secure connections at desired angles between piping. For example, fittings may only be available in angular configurations of 22 degrees, 45, degrees, 90 degrees, or 180 degrees, and may not be dynamically adjustable.

Accordingly, alternative devices and systems for fluid couplings are desired.

### SUMMARY

According to one embodiment, an adjustable drainage coupling includes a housing comprising a first end, a second end, and an inner cavity positioned between the first end and the second end, the second end comprising a securing apparatus, and a drainage pipe comprising an inlet, an outlet, and a pivoting body fluidly coupled to the inlet and the outlet, the pivoting body configured such that the outlet may pivot with respect to the inlet. The drainage pipe is positioned such that the pivoting body of the drainage pipe is enclosed within the inner cavity of the housing, and a locking portion of the outlet is secured to the second end of the housing by the securing apparatus, such that the outlet is secured to the second end of the housing at a desired angle.

According to another embodiment, an adjustable angle drainage coupling includes an inlet portion, an outlet portion, and a contractible flexible chamber portion fluidly coupled to the inlet portion and the outlet portion. The contractible flexible chamber portion includes an outer shell, the outer shell comprising peak regions having a first diameter and valley regions having a second diameter, and a plurality of reinforcing rings having a fixed diameter. The plurality of reinforcing rings is positioned within the contractible flexible chamber portion in peak regions having the first diameter.

According to another embodiment, a fluid direction apparatus includes a fluid directing body comprising an adjustable inlet opening and an adjustable outlet opening, a fluid delivery vessel, and a fluid receiving vessel. The fluid directing body is configured to direct fluid from the fluid delivery vessel to the fluid receiving vessel, and the fluid delivery vessel and the fluid receiving vessel each have a mating end configured to be received by the either the adjustable inlet opening or the adjustable outlet opening. The mating ends of the fluid delivery vessel and the fluid receiving vessel each comprise expandable foam portions and a waterproof film barrier.

According to another embodiment, an adjustable angle pipe elbow includes a first end portion comprising a first threaded face on an inner side of the first end portion, and a second end portion comprising an end mating face on an inner side of the second end portion. The adjustable angle pipe elbow further includes at least one center piece comprising a second threaded face on a first side and a mating face on a second side, the at least one center piece configured to adjust an angle in between the first end portion and the second end portion. The adjustable angle pipe elbow further includes at least one rotating collar positioned around the at least one center piece, the at least one rotating collar configured to join the mating face of the at least one centerpiece to the first threaded face of the first end portion, and at least one detached collar configured to join the end mating face of the second end portion to the second threaded end of the at least one center piece.

### BRIEF DESCRIPTION OF THE DRAWINGS

While the specification concludes with claims particularly pointing out and distinctly claiming the present inventions, it is believed the same will be better understood from the following description taken in conjunction with the accompanying drawings in which:

FIG. 1 is a schematic illustration of one embodiment of an adjustable drainage coupling device according to one or more embodiments shown and described herein;

FIG. 2 is a schematic illustration of another embodiment of an adjustable drainage coupling device in a neutral position according to one or more embodiments shown and described herein;

FIG. 3 is a schematic illustration of the adjustable drainage coupling device of FIG. 2 in an adjusted position according to one or more embodiments shown and described herein;

FIG. 4 is a schematic illustration of another embodiment of an adjustable drainage coupling device according to one or more embodiments shown and described herein;

FIG. 5 is a schematic illustration of the adjustable drainage coupling device of FIG. 4 in an exploded view according to one or more embodiments shown and described herein;

FIG. 6 is a schematic illustration of the adjustable drainage coupling device of FIG. 4 in an adjusted position in exploded view according to one or more embodiments shown and described herein;

FIG. 7 is a schematic illustration of another embodiment of an adjustable drainage coupling device in side view according to one or more embodiments shown and described herein;

FIG. 8 is a schematic illustration of the adjustable drainage coupling device of FIG. 7 in top view according to one or more embodiments shown and described herein;

FIG. 9 is a schematic illustration of an inlet portion of the adjustable drainage coupling device of FIG. 7 in side view according to one or more embodiments shown and described herein;

FIG. 10 is a schematic illustration of a mating end of the inlet portion or outlet portion of the adjustable drainage coupling device of FIG. 7 in side view according to one or more embodiments shown and described herein; and

FIG. 11 is a schematic illustration of another embodiment of an adjustable drainage coupling in perspective view according to one or more embodiments shown and described herein.

The embodiments set forth in the drawings are illustrative and exemplary in nature and not intended to be limiting of the inventions defined by the claims. Moreover, the individual features of the drawings will be more fully apparent and understood in view of the detailed description.

### DETAILED DESCRIPTION

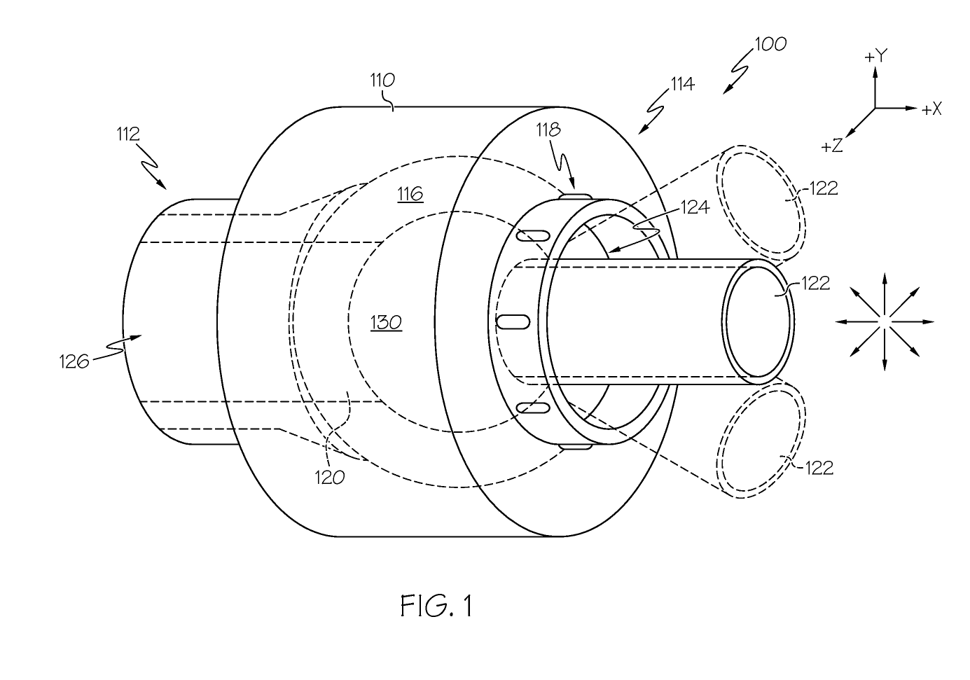

Referring generally to FIG. 1, one embodiment of an adjustable drainage coupling device is illustrated. The adjustable drainage coupling device includes a housing with an inner cavity, a first end, and a second end. The adjustable drainage coupling device further comprises a drainage pipe fluidly coupled to the housing and configured to direct fluid flow. The drainage pipe comprises an inlet, an outlet, and a pivoting body fluidly coupled to the inlet and the outlet. The pivoting body may be configured to pivot and may be dynamically adjustable such that the outlet may be pivotable with respect to the inlet. The pivoting body of the drainage pipe may be positioned within the inner cavity of the housing. The outlet of the drainage pipe may include a locking portion configured to engage with a corresponding securing apparatus positioned on the second end of the housing. The locking portion may engage with the securing apparatus such that the outlet of the drainage pipe is secured at a desired angle, and the securing apparatus may further be configured to arrest movement of the pivoting body. Fluid flowing through the inlet of the adjustable drainage coupling device may therefore enter the pivoting body positioned within the inner cavity of the housing of the adjustable drainage coupling device. The pivoting body may be fluidly coupled to the outlet, and the outlet is secured to the second end of the housing at a desired angle. Accordingly, fluid flows through the pivoting body and may be redirected or the directional energy of the fluid may otherwise be modified depending on the configuration of the pivoting body. Fluid flows through the outlet at the desired angle. Various embodiments of the adjustable fluid coupling device and system will be discussed in detail herein.

Referring now to FIG. 1, one embodiment of an adjustable fluid coupling device 100 is illustrated in schematic view. The adjustable fluid coupling device 100 includes a housing 110 comprising a first end 112, a second end 114, and an inner cavity 116. The adjustable fluid coupling device 100 further includes a drainage apparatus 120. The first end 112 of the housing 110 may comprise, for example, a circumferential opening configured to receive the drainage apparatus 120. The first end 112 may further comprise an attachment portion (not shown) configured to attach the housing 110 to the drainage apparatus 120. For example, the attachment portion may be configured to allow an interference fit with the drainage pipe, a friction fit with the drainage pipe, or another attachment apparatus. The attachment portion may further comprise a retaining seal configured to retain the drainage pipe. The second end 114 of the housing 110 comprises a securing apparatus 118. The securing apparatus 118 may be configured to secure a locking portion 124 of an outlet pipe 122 of the drainage apparatus 120 at a desired angle, as described below. The securing apparatus 118 may comprise, for example, a threaded lock and seal that engages with the corresponding locking portion 124 of the outlet pipe 122, as discussed herein. In other embodiments, the first end 112 may also comprise a securing apparatus configured to secure an inlet pipe 126 of the drainage apparatus 120 at a desired angle.

The adjustable fluid coupling device 100 further includes the drainage apparatus 120. The drainage apparatus 120 comprises the inlet pipe 126, the outlet pipe 122, and a pivoting body portion 130 fluidly coupled to the inlet pipe 126 and the outlet pipe 122. The drainage apparatus 120 may be positioned within the housing 110 of the adjustable fluid coupling device 100 such that the pivoting body portion 130 is positioned within the inner cavity 116. The pivoting body portion 130 may fill a substantial majority of the volume of the inner cavity 116 in some embodiments, while in other embodiments, the pivoting body portion 130 may not fill a substantial majority of the volume of the inner cavity 116 of the housing 110. The pivoting body portion 130 may further alter a fluid velocity of a fluid flowing through the adjustable fluid coupling device 100 by constricting or broadening the volume available for the fluid to flow. For example, to increase the fluid velocity, the pivoting body portion 130 may have a flow volume less than the flow volume of the inlet pipe 126.

The inlet pipe 126 of the drainage apparatus 120 may be configured to direct fluid, for example from a drainage pipe, a sewer, or other plumbing, into the pivoting body portion 130 of the drainage apparatus 120. The inlet pipe 126 may be, for example, any form of pipe and of different materials, such as a cylindrical pipe formed of polyvinyl chloride (PVC), acrylonitrile butadiene styrene (ABS), or a different form of plastic, copper, rubber, or metal. The inlet pipe 126 may have a fixed flow volume and/or fixed diameter, and may be detachable from the pivoting body portion 130 such that a user may couple an inlet portion having a different diameter to the pivoting body portion 130 if desired. The housing 110 and/or the drainage apparatus 120 may further include an inner sleeve positioned within the housing 110 or the drainage apparatus 120, or both. The inner sleeve may be configured to prevent residue or sediment buildup in the housing 110 from fluid flowing through the adjustable drainage coupling 100.

The pivoting body portion 130 is fluidly coupled to the inlet and the outlet pipes 126, 122 and may include gaskets or seals at coupling joints for sealing purposes. The pivoting body portion 130 may be configurable to direct the fluid flow in a desired direction and may also adjust fluid properties such as directional energy and/or fluid velocity. The pivoting body portion 130 may comprise, for example, a ball and socket joint, a fluid swivel apparatus, or another apparatus configured to allow the outlet pipe 122 to translate or rotate with respect to the inlet pipe 126. The pivoting body portion 130 may also be formed of PVC plastic or ABS copper in some embodiments, or may be formed from another plastic, a metal, a flexible rubber, or a combination thereof. The pivoting body portion 130 may be a two-piece assembly, with a ball joint fluidly engaged with a socket portion, or may be a one-piece assembly configured to flexibly adjust an angle between the inlet pipe 126 and the outlet pipe 122. In other embodiments, the pivoting body portion 130 may comprise additional elements.

The outlet pipe 122 may be formed of the same material as the inlet pipe 126 and/or the pivoting body portion 130. The outlet pipe 122 may allow fluid to flow away from the pivoting body portion 130 of the adjustable fluid coupling device 100. The outlet pipe 122 may be detachable from the pivoting body portion 130, allowing a user flexibility in coupling an outlet portion having a different diameter, for example, to the pivoting body portion 130. The outlet pipe 122 may be configured to pivot or rotate with respect to the inlet pipe 126 due to the rotational functionality of the pivoting body portion 130. For example, in instances where the pivoting body portion 130 is a ball and socket joint, the outlet pipe 122 may be manually configurable to move along the X-axis, Y-axis, or Z-axis as shown in FIG. 1. The pivoting body portion 130 may allow the outlet pipe 122 to have a wide range of motion along each of the X, Y, and Z axes. The outlet pipe 122 may therefore be manually positionable at a desired angle and secured to the housing 110 with securing apparatus 118. The inlet pipe 126 may also be moveable with respect to the outlet pipe 122, such that the inlet pipe 126 is positioned and secured at a desired angle. Further, the outlet pipe 122 may have the same diameter as the inlet pipe 126 in some embodiments, while in other embodiments the outlet pipe 122 may have a different diameter than the inlet pipe 126, allowing for flow speed of a fluid within the adjustable fluid coupling device 100 to be manipulated.

The outlet pipe 122 may comprise the locking portion 124, allowing the outlet pipe 122 to be secured to the housing 110 at a desired angle. The locking portion 124 may engage with the securing apparatus 118 of the second end 114 of the housing 110. As discussed herein, the securing apparatus 118 may include a threaded lock and seal sleeve, which may be configured to engage the locking portion 124 of the outlet pipe 122. Accordingly, fluid may flow through the inlet pipe 126 at a first angle relative to the outlet and at a first fluid velocity. The fluid may enter the pivoting body portion 130, which may be configured to adjust the angle and velocity of fluid flow such that the angle of fluid flow matches the angle of the outlet pipe 122 with respect to the inlet pipe 126. The fluid may then flow out of the pivoting body portion 130 and through the outlet pipe 122 at the desired angle and velocity.

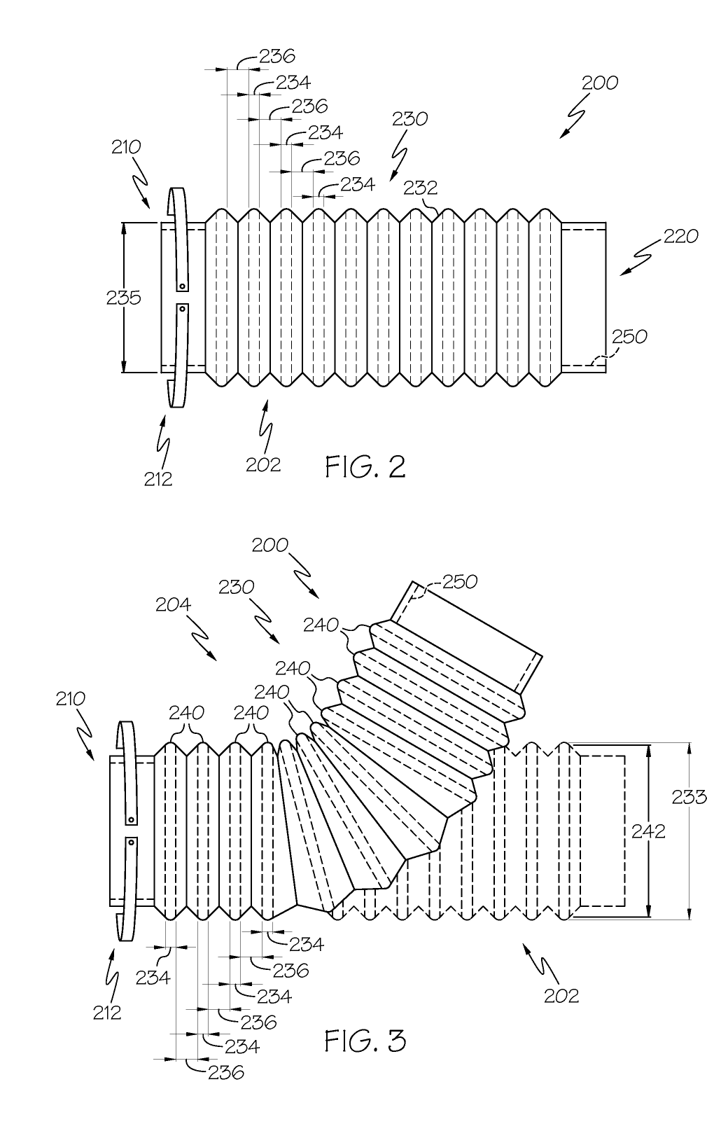

Referring now to FIGS. 2-3, another embodiment of an adjustable drainage coupling device 200 is schematically depicted. In this embodiment, the adjustable drainage coupling device 200 includes a contractible flexible chamber portion 230 with an inlet 210 and an outlet 220. The inlet 210 may comprise an attachment portion, such as clamping system 212, allowing the inlet 210 to be connected and/or fluidly coupled to a fluid delivery source (not shown) such as a sewer or other plumbing. Similarly, the outlet 220 may comprise an attachment portion configured to attach the outlet 220 to a fluid receptacle or another fluid pipe (not shown).

The contractible flexible chamber portion 230 may include an outer shell 232 and, in some embodiments, a plurality of reinforcing rings as discussed below. In FIG. 2, the adjustable drainage coupling device 200 is shown in a neutral position 202, in which the contractible flexible chamber portion 230 is depicted as substantially linear. The contractible flexible chamber portion 230 may be formed from, for example, PVC or high density polyethylene plastic, and may comprise peak regions 234 and valley regions 236. For ease in illustration, only a few sample peak regions 234 and valley regions 236 are labeled with element numbers. The peak regions 234 may be formed from a higher density plastic, for example, or from a different material than the valley regions 236. In other embodiments, the peak regions 234 may have different dimensions than the valley regions 236. For example, the peak regions 234 may be formed from the same material as the valley regions 236, but may have an increased thickness. This may allow the peak regions 234 to remain rigid, while still allowing the peak regions 234 to move or rotate with respect to the thinner valley regions 236, allowing the contractible flexible chamber portion 230 to be configured at a desired angle. In yet other embodiments, the peak regions 234 may be formed from the same material as the valley regions 236, but may have different material properties and may be joined to the valley regions 236 through various connections and/or manufacturing processes. For example, the valley regions 236 may be formed from a lower density plastic than the peak regions 234 and the valley regions 236 may be connected to the peak regions 234 by co-molded or living hinges, allowing the peak regions 234 to rotate and/or otherwise move with respect to the valley regions 236. Different regions, for example the peak regions 234 and valley regions 236 may be painted different colors, providing aesthetic appeal if desired.

Referring now to FIG. 3, the adjustable drainage coupling device 200 is shown in an adjusted position 204. The material properties and dimensions of the outer shell 232 of the contractible flexible chamber portion 230 may be selected to ensure that when the adjustable drainage coupling device 200 is moved into the adjusted position 204 from the neutral position 202, the outer shell 232 initially resists another change in position until a certain force is applied. Until the resisting force created by the outer shell 232 is overcome, the adjustable drainage coupling device 200 may not be further adjusted to another position or returned to the neutral position 202. The outer shell 232 may further be contractible, allowing a user to adjust a length of the outer shell 232 as desired.

The adjustable drainage coupling device 200 may further include reinforcing rings 240 (shown only in FIG. 3) positioned within the contractible flexible chamber portion 230. The reinforcing rings 240 may be positioned such that an outer circumference 242 of each reinforcing ring 240 engages an inner circumference 233 of the outer shell 232. The reinforcing rings 240 may provide structural support to the contractible flexible chamber portion 230. The reinforcing rings 240 may have fixed diameters in some embodiments, while in other embodiments the reinforcing rings 240 may be flexible. Additionally, in some embodiments each of the reinforcing rings 240 may have equal diameters, while in other embodiments, the reinforcing rings 240 may have different diameters which may allow an overall diameter 235 of the contractible flexible chamber portion 230 to change, thereby adjusting fluid velocity through the contractible flexible chamber portion 230. The reinforcing rings 240 may be formed of metal, such as steel or aluminum, or may also be formed of plastic or rubber. In some embodiments the outer shell 232 may be overmolded over the reinforcing rings 240, and the reinforcing rings 240 may expand the contractible flexible chamber portion 230 to form the peak regions 234. Although discussed herein as reinforcing rings 240 with circumferences, it is understood that the reinforcing rings 240 may not be circumferential and may have alternative geometries, such as rectangular or hexagonal.

In some embodiments, the contractible flexible chamber portion 230 may further comprise an inner shell 250, as illustrated in FIG. 3. The inner shell 250 may be formed from a more rigid material or less rigid material than the outer shell 232 and may be removably attached to the outer shell 232. Additionally, the inner shell 250 may have material properties that aid in the flow of fluid through the contractible flexible chamber portion 230. For example, the inner shell 250 may be anti-microbial or may structurally support the outer shell 232 in order to maintain structural integrity of the adjustable drainage coupling device 200 to maintain a desired position. The inner shell 250 may reduce sediment buildup, as discussed above. An embodiment of the adjustable drainage coupling device 200 with the inner shell 250 may be formed by an overmold process, where the outer shell 232 is overmolded onto the inner shell 250, for example. The reinforcing rings 240 may be positioned within the inner shell 250 in this embodiment, or may be positioned around the inner shell 250 and inside the outer shell 232. Further, the inner sleeve may be reinforced with, for example, a braided material including steel and/or rubber braiding.

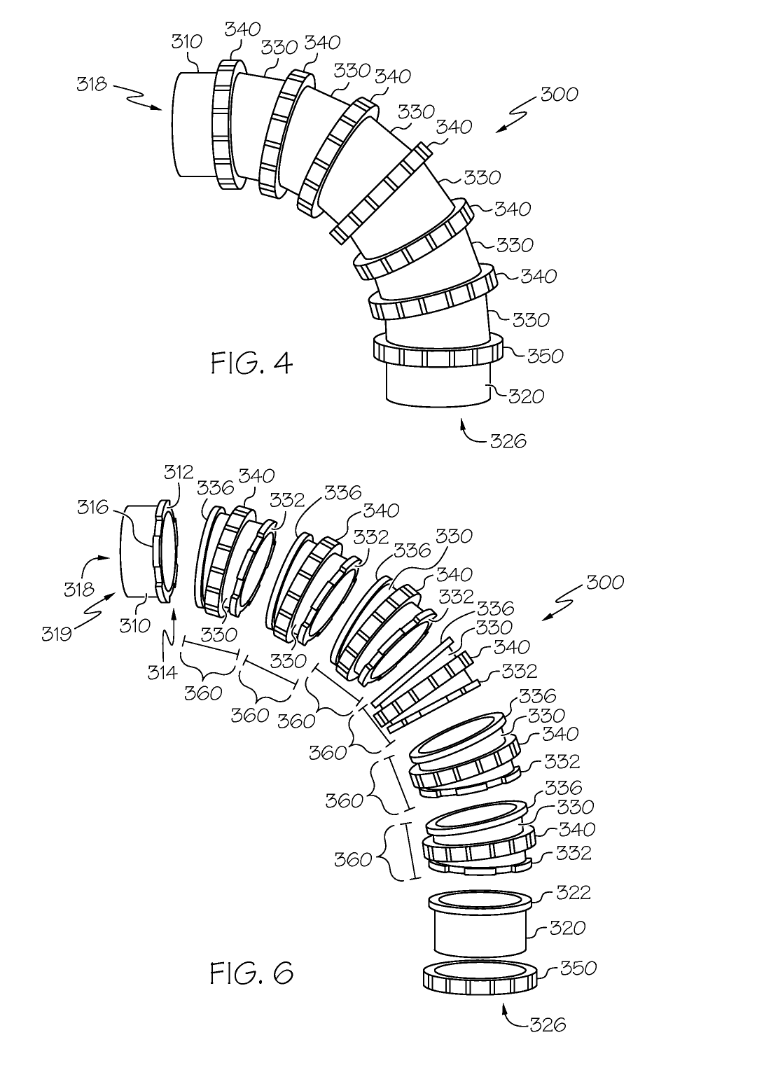

Referring now to FIGS. 4-6, another embodiment of an adjustable drainage coupling device 300 is depicted as a pipe elbow. In the illustrated embodiment, the adjustable drainage coupling device 300 includes a first end portion 310, a second end portion 320, and at least one center piece 330. The adjustable drainage coupling device 300 may include at least one rotating collar 340 to connect the center piece 330 to the first end portion 310, and at least one detached collar 350 to connect the center piece 330 to the second end portion 320.

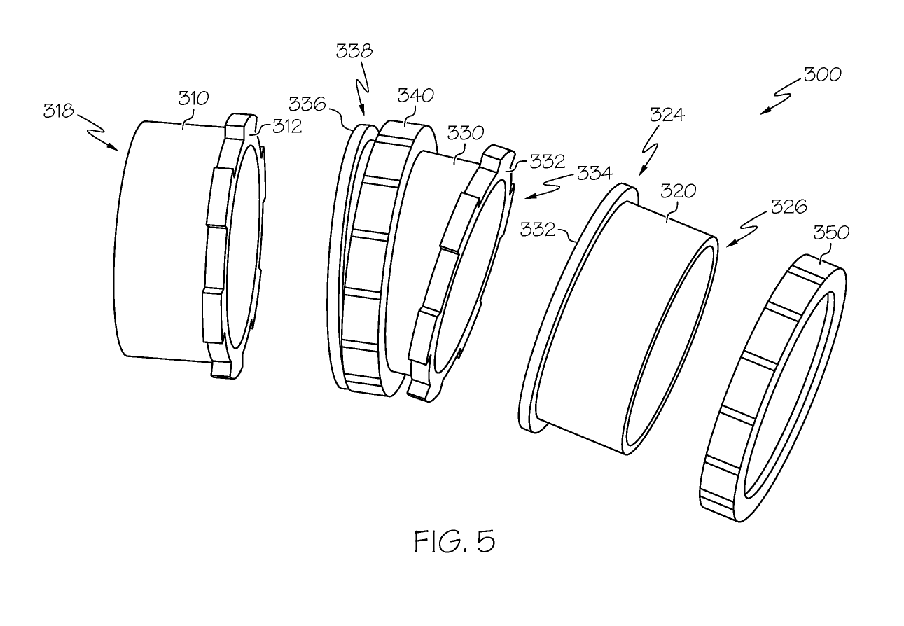

Referring to FIG. 5, the first end portion 310 may include a first threaded face 312 on a first side 314 of the first end portion 310. The first threaded face 312 may include threads 316 extending about a circumferential periphery of the first end portion 310. The first threaded face 312 may be configured to engage with the rotating collar 340 to secure one of the at least one center pieces 330 to the first end portion 310, for example. In other embodiments, the first threaded face 312 may be configured to receive corresponding threads or openings on the rotating collar 340 in order to secure the first end portion 310 to the center piece 330. The first end portion 310 may further include an inlet portion 318 on a second side 319, the inlet portion 318 configured to receive fluid from a fluid delivery source (not shown) such as a sewer or plumbing.

The center piece 330 may include a second threaded face 332 on a first side 334 proximate to the second end portion 320, and may include a mating face 336 on a second side 338 proximate to the first end portion 310. The second threaded face 332 may be identical to the first threaded face 312, or may have different threads. If the first and second threaded faces 312, 332 are identical, manufacturing costs and difficulty in manufacturing may be reduced. The mating face 336 may be a lip extending circumferentially about the periphery of the second side 338 of the center piece 330 and may be configured to mate flush against the first threaded face 312 of the first end portion 310 to form a watertight seal. In some embodiments, the mating face 336 may also be identical to the first or second threaded faces 312, 332.

The second end portion 320 includes an end mating face 322 on a first side 324 of the second end portion 320. The end mating face 322 may be relatively smooth and flat, as shown in FIG. 6, and may include a lip extending circumferentially about the periphery of the first side 324 of the second end portion 320. Other embodiments may not include the lip and may instead utilize a different mechanism to provide a mating surface for the second end portion 320 and the center piece 330, such as a threaded face that may match the first or second threaded faces 312, 332. The second end portion 320 also includes a second side 326 that may be fluidly coupled to a fluid receptacle (not shown) where fluid flowing through the adjustable drainage coupling device 300 may flow. The first end portion 310, the second end portion 320, and the center piece 330 may all have the same diameter, or may have different diameters to adjust fluid velocity as discussed herein.

The adjustable drainage coupling device 300 further includes the rotating collars 340 and detached collar 350. The rotating collars 340 and detached collar 350 have slightly larger diameters than the first and second end portions 310, 320, as well as the center piece 330 of the adjustable drainage coupling system 300. In some embodiments, the rotating collars 340 and the detached collar 350 may be structurally identical, but with the rotating collars 340 attached to the center pieces 330 and the detached collar 350 separate from the center pieces. One rotating collar 340 may be configured to join the mating face 336 of the center piece 330 to the first threaded face 312 of the first end portion 310. In embodiments with multiple center pieces 330, rotating collars 340 may also be configured to join mating faces of each center piece with other center pieces. The rotating collar 340 may freely rotate about the center piece 330 in some embodiments, but may not be detachable from the center piece 330. For example, the rotating collar 340 may be disposed about the center piece 330 prior to welding or joining the second threaded face 332 or the mating face 336 onto the center piece 330. The detached collar 350 may be detachable from the adjustable drainage coupling device 300 and may be freely rotatable about the center piece 330, the first end portion 310, or the second end portion 320. The detached collar 350 may be configured to join the end mating face 322 of the second end portion 320 to the second threaded face 332 of the center piece 330. The rotating and detached collars 340, 350 may be configured to threadably engage the threaded faces 312, 332 and/or mating faces 322, 336 of the first end portion 310, the center piece 330, and/or the second end portion 320 and to secure the center piece 330 to the first end portion 310 and/or the second end portion 320. A retaining seal or sealing member (not shown) may be disposed in between any of the elements of the adjustable drainage coupling device 300 to help ensure a watertight seal.

In the embodiment of the adjustable drainage coupling device 300 illustrated in FIGS. 4-6, additional center pieces 330 may be added to adjust the overall angle between the first end portion 310 and the second end portion 320. Referring now to FIG. 6, each center piece 330 may increase the angle by a fixed number of degrees 360. For example, each center piece 330 may increase the angle between the first end portion 310 and the second end portion 320 by 15 degrees. Accordingly, if the desired angle is 90 degrees, six center pieces 330 will be needed to achieve the 90 degree change in fluid direction between the first end portion 310 and the second end portion 320. The adjustable drainage coupling device 300 with six center pieces 330 is illustrated in FIG. 6. As shown, the adjustable drainage coupling device 300 functions similar to a pipe elbow. In order to adjust the angle between the first end portion 310 and the second end portion 320, center pieces 330 may be added or removed from the adjustable drainage coupling device 300. In other embodiments, center pieces 330 may not change the angle between the first and second end portions 310, 320 by 15 degrees, and may instead change the angle between the first and second end portions 310, 320 by more or less than 15 degrees, for example 30 degrees or 10 degrees. Increasing the curvature of the center pieces 330 may result in less precise control over the angular configuration of the adjustable drainage coupling device 300 but may result in cheaper costs due to less components, whereas decreasing the curvature of the center pieces 330 may result in increased control over the angular configuration of the adjustable drainage coupling device 300 but may result in higher costs due to an increased number of components needed to achieve a certain angular configuration, as well as increased potential for fluid leaks.

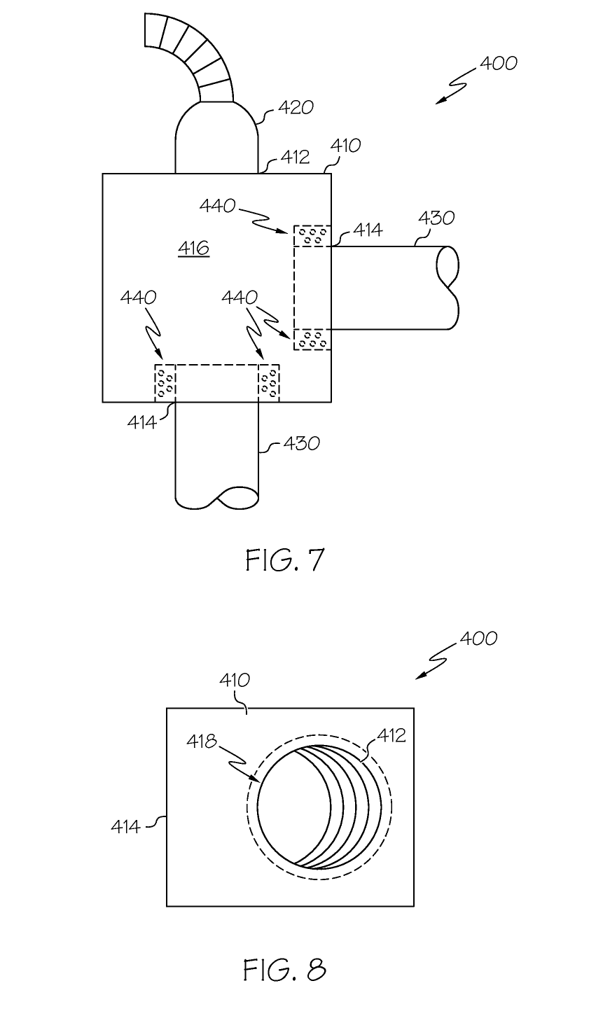

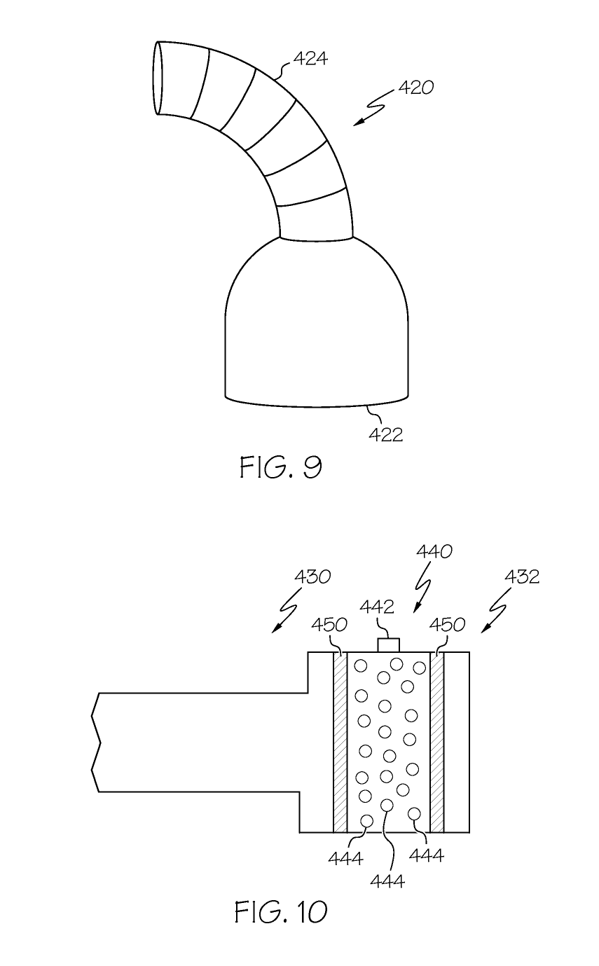

Referring now to FIGS. 7-10, another embodiment of an adjustable drainage coupling device 400 is schematically depicted. The adjustable drainage coupling device 400 includes a fluid directing body 410, a fluid delivery vessel 420, and one or more fluid receiving vessels 430. The fluid delivery vessel 420, shown in FIG. 9, may comprise a mating end 422 that is fluidly coupled to an adjustable angle inlet opening 412 of the fluid directing body 410. Similarly, each fluid receiving vessel 430 may comprise a mating end 432 that is fluidly coupled to an adjustable angle outlet opening 414 of the fluid directing body 410. The fluid delivery vessel 420 and the fluid receiving vessels 430 may include standard pipe fittings as mating ends 422, 432, respectively. The mating ends 422, 432 may be configured to be positioned and secured within the adjustable angle inlet and outlet openings 412, 414 of the fluid directing body 410. The mating ends 422, 432 may be secured to the fluid directing body 410 with, for example, cement or pipe glue such as pvc glue and primer, epoxy, 2-part epoxy, and the like.

Referring now to FIG. 9, the fluid delivery vessel 420 may include a flexible extended body 424 having an adjustable length extending from the mating end 422 of the fluid delivery vessel 420. The fluid delivery vessel 420 may be configured to deliver fluid to the fluid directing body 410. The fluid delivery vessel 420 may be, for example, a circumferential pipe formed from PVC or ABS materials. In some embodiments, the fluid delivery vessel 420 may include various cut lines that allow portions of the fluid delivery vessel 420 to be removed, thereby allowing different coupling angles to be formed between the fluid delivery vessel 420 and the fluid directing body 410.

The mating ends 422, 432 of the fluid delivery vessel 420 and the fluid receiving vessel 430 may comprise standard end fittings, such as 3 inch diameter pipes, 4 inch diameter pipes, and other common drain pipe sizes. The mating ends 422, 432 of the fluid delivery vessel 420 and the fluid receiving vessel 430 may comprise expandable foam portions 440. Although the expandable foam portion 440 is only illustrated in FIG. 10 as part of the fluid receiving vessel 430, it is understood that the fluid delivery vessel 420 may also comprise the expandable foam portion 440. The expandable foam portion 440 may include an air cap 442 configured to actuate the expandable foam portion 440 and automatically inflate the expandable foam portion 440 with air pockets 444. The expandable foam portion 440 may comprise a waterproof coating. The expandable foam portion 440 may be actuated when the fluid delivery vessel 420 and/or the fluid receiving vessel 430 is positioned within the adjustable angle inlet and outlet openings 412, 414 of the fluid directing body 410 at the desired angle. The air cap 442 may allow air to flow into the expandable foam portion 440, thereby inflating the expandable foam portion 440 and reducing any gap between the adjustable angle inlet and outlet openings 412, 414 and the fluid delivery vessel 420 and/or the fluid receiving vessel 430. The expandable foam portion 440 may therefore create a tighter seal between the fluid delivery vessel 420 and/or the fluid receiving vessel 430 and the fluid directing body 410.

The mating ends 422, 432 of the fluid delivery vessel 420 and the fluid receiving vessel 430 may further comprise waterproof film barriers 450. The waterproof film barriers 450 may be disposed about the expandable foam portion 440 such that when the expandable foam portion 440 is fully expanded or inflated, the waterproof film barrier 450 is positioned between the fluid directing body 410 and the fluid delivery or fluid receiving vessel 420, 430 such that a waterproof seal is formed, preventing fluid leaking from the adjustable drainage coupling device 400.

The fluid directing body 410 includes a fluid redirecting cavity 416 positioned within the fluid directing body 410 and configured to direct fluid through the fluid directing body 410. The fluid directing body 410 may direct the fluid to the fluid receiving vessel 430 or to multiple fluid receiving vessels 430. The fluid redirecting cavity 416 may include an inner coating such that residue and sediment may not be retained in the fluid redirecting cavity 416.

The fluid directing body 410 may include the adjustable angle inlet and outlet openings 412, 414 comprising a plurality of removable punch out portions 418, with each punch out portion 418 configured for a different mating angle between the fluid directing body 410 and the fluid receiving vessel 430 and/or the fluid delivery vessel 420. For example, punch out portions 418 may be circular for a straight coupling, or a 90 degree mating angle between the fluid directing body 410 and the fluid receiving vessel 430 and/or the fluid delivery vessel 420. In embodiments where a different mating angle is desired, the respective punch out portion 418 may be elliptical in geometry and may vary in size as the mating angle increases or decreases.

In some embodiments, the punch out portions 418 may be a one-time removable punch out, in that the punch out portion 418 is destructively attached to the fluid directing body 410. In other embodiments, the punch out portions 418 may be non-destructively attached to the fluid directing body 410, allowing the fluid directing body 410 to be reused when a new angle between the fluid directing body 410 and the fluid delivery vessel 420 or fluid receiving vessel 430 is desired. The punch out portions 418 may be included on some or all of the surfaces of the fluid directing body 410, such that fluid may flow in or out of any of the surfaces.

The fluid receiving vessel 430 may be positioned at a closer distance to ground level than the fluid delivery vessel 420, allowing fluid to pass through the fluid directing body 410 due to gravity. The fluid directing body 410 may also be configured to couple two separate fluid delivery portions into a single fluid receiving portion, or may decouple a single fluid delivery portion into a plurality of fluid receiving portions.

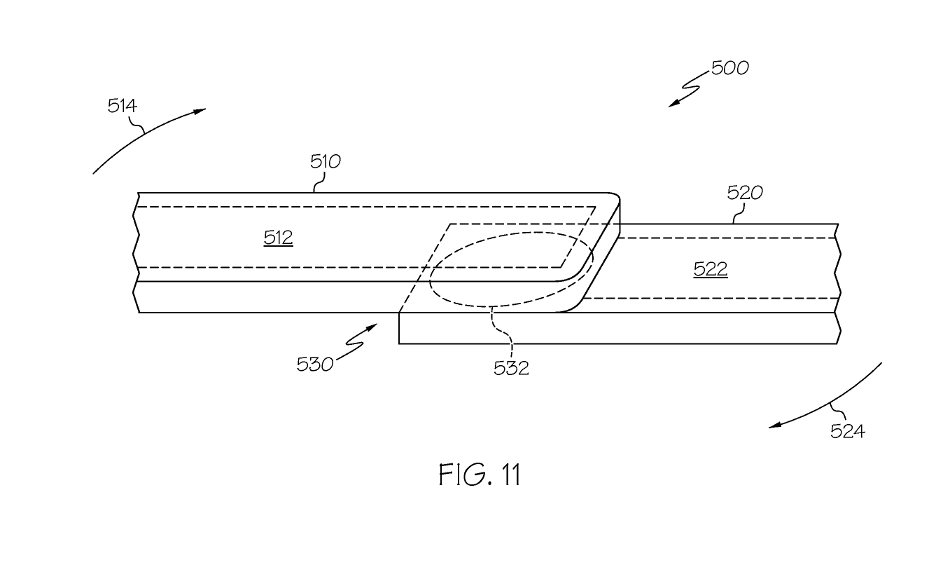

Referring now to FIG. 11, another embodiment of an adjustable drainage coupling device 500 is schematically depicted. The adjustable drainage coupling device 500 includes a first arm 510, a second arm 520, and a swivel connection 530 fluidically joining the first arm 510 to the second arm 520. The first arm 510 may be, for example, a box-like hollow structure with an inner cavity 512 configured to allow fluid to pass through and/or be retained in the first arm 510. Similarly, the second arm 520 may be, for example, a box-like hollow structure with an inner cavity 522 configured to allow fluid to pass through and/or be retained in the second arm 520. The first and second arms 510, 520 may be formed of plastic, including polyethylene, and may be manufactured from blow molding or injection molding processes, for example. In other embodiments, the first and second arms 510, 520 may have alternative shapes, such as cylindrical or elliptical shapes. In the illustrated embodiment, the adjustable drainage coupling device 500 may be positioned in areas having low width and/or height requirements, for example underneath contemporary vanities or in between appliances and walls. The illustrated embodiment may also be aesthetically pleasing in that the first and second arms 510, 520 may be painted in different colors and/or finishes, for example matte or glossy. Additionally, the first and second arms 510, 520 include fittings on connection ends (not shown) that allow fluid to enter or exit the adjustable drainage coupling device 500. The connection ends may be standard fittings, such as standard plumbing fitting connections, or other fittings designed to create a fluidtight connection with the adjustable drainage coupling device 500.

The adjustable drainage coupling device 500 includes the swivel connection 530. The swivel connection 530 fluidically couples the inner cavity 512 of the first arm 510 to inner cavity 522 of the second arm 520. The swivel connection 530 may include a rubber and/or steel bearing or grommet 532 that may create a fluidtight seal between the inner cavities 512, 522, allowing fluid to flow in any direction between the inner cavities 512, 522. The swivel connection 530 further allows either the first arm 510 to rotate and/or swivel with respect to the second arm 520, or the second arm 520 to rotate and/or swivel with respect to the first arm 510. For example, the first arm 510 may rotate in direction 514, while the second arm 520 may rotate in direction 524. The first and second arms 510, 520 may therefore rotate while the inner cavities 512, 522 maintain a fluidic connection. This allows the adjustable drainage coupling device 500 to create an infinitely adjustable angle between the first and second arms 510, 520, and further to allow fluid to flow through the inner cavities 512, 522 of the first and second arms 510, 520 as the angle between the first and second arms 510, 520 is adjusted. Depending on the geometry of the first and second arms 510, 520, the adjustable drainage coupling device 500 may be useful in transporting fluid through areas having space restrictions, as discussed above.

The devices and systems of the illustrated embodiments of the present disclosure may also provide one or more of the following advantages: simplify drainage connections of all angles due to adjustable angle configurations; allow proper watertight seals to be formed; reduce difficulty of installation; reduced tooling required and no cutting involved; and reusable devices and systems as angular configuration is repeatedly adjustable.

The foregoing description of the embodiments has been presented for purposes of illustration and description. It is not intended to be exhaustive or to limit the disclosure to the precise form disclosed. Many alternatives, modifications, and variations will be apparent to those skilled in the art in light of the above teaching. Accordingly, it is intended to embrace all alternatives, modifications, and variations that fall within the spirit and broad scope of the claims.

What is claimed is:

1. An adjustable drainage coupling comprising:
a housing comprising a first end, a second end, and an inner cavity positioned between the first end and the second end, the second end comprising a securing apparatus; and
a drainage apparatus comprising an inlet pipe, an outlet pipe, and a pivoting body fluidly coupled to the inlet pipe and the outlet pipe, the pivoting body configured such that the outlet pipe may pivot with respect to the inlet pipe;
wherein the drainage apparatus is positioned such that the pivoting body of the drainage apparatus is enclosed within the inner cavity of the housing, and a locking portion of the outlet pipe is secured to the second end of the housing by the securing apparatus, such that the outlet pipe is secured to the second end of the housing at a desired angle.

2. The adjustable drainage coupling of claim 1, wherein the securing apparatus is a threaded lock and seal sleeve configured to secure the locking portion of the outlet pipe.

3. The adjustable drainage coupling of claim 1, wherein the pivoting body is rotatable such that the inlet pipe may rotate with respect to the outlet pipe.

4. The adjustable drainage coupling of claim 1, wherein the drainage apparatus is removable from the housing.

5. The adjustable drainage coupling of claim 1, wherein the pivoting body is comprised of a ball and socket connection.

6. An adjustable drainage coupling comprising:
an inlet portion;
an outlet portion; and
a contractible flexible chamber portion fluidly coupled to the inlet portion and the outlet portion, the contractible flexible chamber portion comprising an outer shell, the outer shell comprising peak regions having a first diameter and valley regions having a second diameter.

7. The adjustable drainage coupling of claim 6, wherein the first diameter is greater than the second diameter.

8. The adjustable drainage coupling of claim 6, further comprising a plurality of reinforcing rings having a fixed diameter;
wherein the plurality of reinforcing rings is positioned within the contractible flexible chamber portion in peak regions having the first diameter.

9. The adjustable drainage coupling of claim 8, wherein the first diameter of the peak region and the fixed diameter of the plurality of reinforcing rings is substantially equal.

10. The adjustable drainage coupling of claim 8, further comprising a flexible waterproof inner shell, wherein the plurality of reinforcing rings are positioned in between the outer shell and the flexible waterproof inner shell.

11. The adjustable drainage coupling of claim 6, wherein the peak regions of the outer shell of the contractible flexible chamber portion have a first wall thickness, the valley regions of the outer shell of the contractible flexible chamber portion have a second wall thickness, and the first wall thickness is greater than the second wall thickness.

12. The adjustable drainage coupling of claim 6, wherein the peak regions of the outer shell of the contractible flexible chamber portion are formed from a different material than the valley regions of the outer shell of the contractible flexible chamber portion.

13. The adjustable drainage coupling of claim 6, further comprising a braided flexible tubing inner sleeve, the braided flexible tubing reinforced with braiding comprised of steel.

14. A fluid direction apparatus comprising:
a fluid directing body comprising an adjustable inlet opening and an adjustable outlet opening;
a fluid delivery vessel; and
a fluid receiving vessel;
wherein the fluid directing body is configured to direct fluid from the fluid delivery vessel to the fluid receiving vessel;
the fluid delivery vessel and the fluid receiving vessel each have a mating end configured to be received by the either the adjustable inlet opening or the adjustable outlet opening; and
the mating ends of the fluid delivery vessel and the fluid receiving vessel each comprise expandable foam portions and a waterproof film barrier.

15. The fluid direction apparatus of claim 14, wherein the fluid directing body further comprises removable punch out portions covering either the adjustable inlet opening or the adjustable outlet opening.

16. The fluid direction apparatus of claim 14, wherein the expandable foam portion is actuated by an air cap configured to allow a gas to enter the expandable foam portion.

17. An adjustable angle pipe elbow comprising:
a first end portion comprising a first threaded face on an inner side of the first end portion;
a second end portion comprising an end mating face on an inner side of the second end portion;
at least one center piece comprising a second threaded face on a first side and a mating face on a second side, the at least one center piece configured to adjust an angle in between the first end portion and the second end portion;
at least one rotating collar positioned around the at least one center piece, the at least one rotating collar configured to join the mating face of the at least one center piece to the first threaded face of the first end portion; and
at least one detached collar configured to join the end mating face of the second end portion to the second threaded face of the at least one center piece.

18. The adjustable angle pipe elbow of claim 17, wherein the at least one center piece is configured to adjust the angle in between the first end portion and the second end portion by about 15 degrees.

19. The adjustable angle pipe elbow of claim 18, wherein the at least one center piece is configured to adjust the angle in between the first end portion and the second end portion by about 30 degrees.

20. The adjustable angle pipe elbow of claim 17, further comprising a sealing retainer disposed on the mating face of the at least one center piece, the sealing retainer configured to prevent fluid flow.

21. The adjustable angle pipe elbow of claim 17, wherein the at least one rotating collar and the at least one detached collar are structurally identical.

22. An adjustable drainage coupling comprising:
a first arm comprising an inlet portion, an outlet portion, and an inner cavity fluidly coupled to the inlet portion and the outlet portion;
a second arm comprising an inlet portion, an outlet portion, and an inner cavity fluidly coupled to the inlet portion and the outlet portion; and
a swivel connection comprising a sealing portion, the swivel connection configured to create a fluidic connection between the outlet portion of the first arm to the inlet portion of the second arm;
wherein the swivel connection is configured to allow the first arm to swivel with respect to the second arm while maintaining the fluidic connection, and the sealing portion creates a fluidtight seal between the outlet portion of the first arm and the inlet portion of the second arm.
